(19) United States
(12) Patent Application Publication
(10) Pub. No.: US 2018/0187801 A1
(43) Pub. Date: Jul. 5, 2018

(54) ARTICLE WITH TUNABLE FLEXIBILITY USING REVERSIBLE CROSS-LINKING FLUIDS

(71) Applicant: International Business Machines Corporation, Armonk, NY (US)

(72) Inventors: Sarah K. CZAPLEWSKI, Rochester, MN (US); Brandon M. KOBILKA, Tucson, AZ (US); Jason T. WERTZ, Pleasant Valley, NY (US); Jing ZHANG, Poughkeepsie, NY (US)

(21) Appl. No.: 15/398,947

(22) Filed: Jan. 5, 2017

(51) Int. Cl. F16L 11/00; F16L 11/12; F16L 21/02; F16L 11/127

(52) U.S. Cl. CPC F16L 11/005; F16L 11/127; F16L 21/02; F16L 11/12

(57) ABSTRACT

A hose, connector, and hose assembly are described with mechanical properties that can be varied by exposure to specific energy stimuli. The hose has a wall with a first material, a second material, and one or more energy conduits, wherein the first material has a first rigidity with a first variability, and the second material has a second rigidity with a second variability, the first variability depends on energy emitted from the one or more energy conduits, and the second variability is substantially independent of energy emitted from the one or more energy conduits. The second material may be disposed in inclusions that are positioned in the wall. The connector connects two such hoses together, providing connectivity for the inclusions and the energy conduits of two lengths of hose. The connector also provides an external connection to couple an energy source to the energy conduits of the hose.

### BACKGROUND

The present invention relates to articles having components made of materials with reversible cross-linking providing variable properties.

Articles such as tubes, hoses, and sheets are typically made of a material that has a set degree of rigidity or flexibility depending on the application. The article is formed from the material, and its mechanical properties are set when the article is formed, or shortly thereafter in the case of articles that are cured after forming. A way is needed to make tubes, hoses, and other articles with mechanical properties that can be adjusted at will after formation of the article.

### SUMMARY

Embodiments described herein provide a hose, comprising a wall with a first material, a second material, and one or more energy conduits, wherein the first material has a first rigidity with a first variability, and the second material as a second rigidity with a second variability, the first variability depends on energy emitted from the one or more energy conduits, and the second variability is substantially independent of energy emitted from the one or more energy conduits.

Other embodiments described herein provide a connector for a hose assembly, the connector comprising a first portion having a protrusion with a first axial passage; and a second portion having a recess that mates to the protrusion, the recess having a second axial passage that aligns with the first axial passage when the recess is mated to the protrusion, wherein the first portion has a plurality of peripheral passages formed through a peripheral region of the first portion radially inward of an edge of the first portion and extending along an axial direction of the connector.

Other embodiments described herein provide a hose assembly, comprising a first hose length comprising a first wall with a continuous phase made of a first material, a first plurality of inclusions made of a second material, and one or more first energy conduits, wherein the first material has a first rigidity with a first variability, and the second material has a second rigidity with a second variability, the first variability depends on energy emitted from the one or more first energy conduits, and the second variability is substantially independent of energy emitted from the one or more first energy conduits; a second hose length comprising a second wall with a continuous phase made of the first material, a second plurality of inclusions made of the second material, and one or more second energy conduits; and a connector for joining the first hose length to the second hose length, the connector comprising a first portion coupled to the first hose length and a second portion coupled to the second hose length, the first portion having a plurality of peripheral passages parallel to an axis of the connector and aligned with the first plurality of inclusions and the one or more first energy conduits to receive the second plurality of inclusions and the one or more second energy conduits.

The above-described and other features and advantages of the present invention will be appreciated and understood by those skilled in the art from the following detailed description, drawings, and appended claims.

BRIEF DESCRIPTION OF THE SEVERAL VIEWS OF THE DRAWINGS

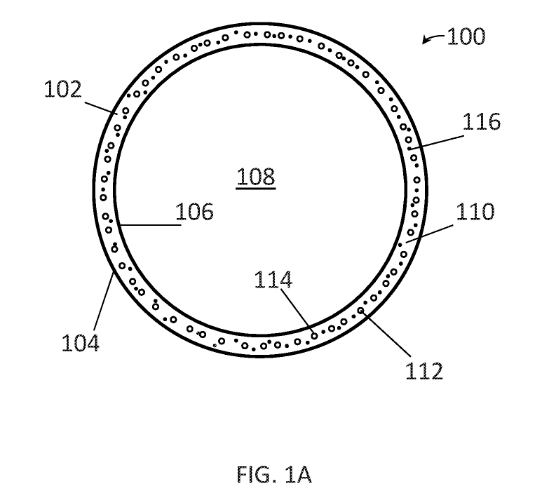

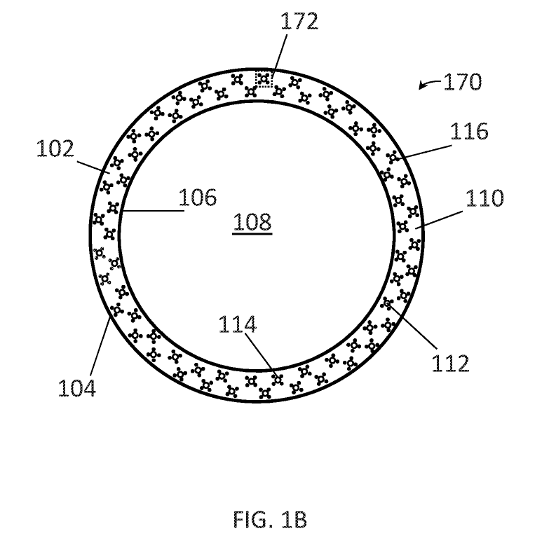

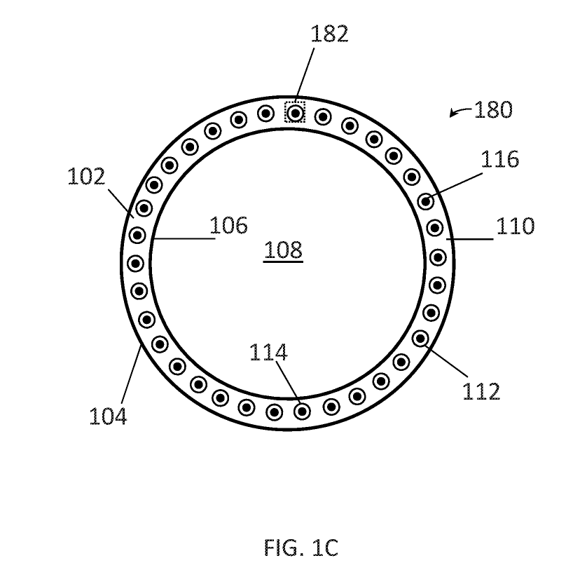

FIGS. 1A-1C are cross-sectional diagrams of different embodiments of hoses.

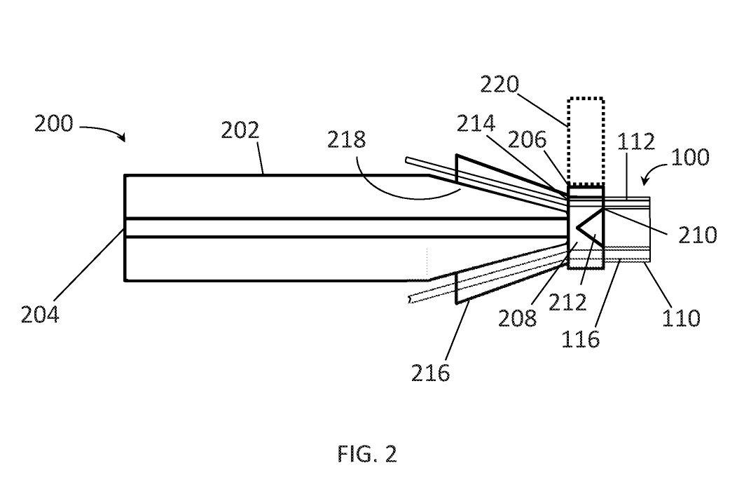

FIG. 2 is a schematic cross-sectional view of an extrusion apparatus for making the hoses of FIGS. 1A-1C.

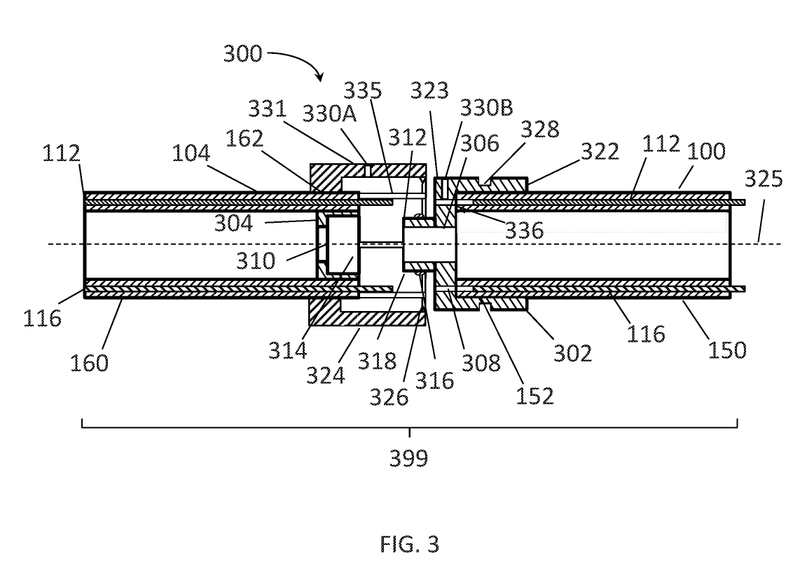

FIG. 3 is a cross-sectional view of a connector that may be applied to the hoses of FIGS. 1A-1C to form a hose assembly.

### DETAILED DESCRIPTION

The inventors have developed a way of making articles that have mechanical properties that can be adjusted, after the article is formed, by exposure to energy. These articles contain materials that, when exposed to radiant or thermal energy, change their molecular composition to provide different mechanical properties. In some cases, the change in mechanical properties can depend on the degree of exposure to the energy, such that longer or more intense exposure to energy provokes a larger change while shorter or less intense exposure causes a smaller change. Also, in some cases, different locations of the article exposed to different amounts of energy may exhibit different responses such that a first portion of the article has a first value of a mechanical property, a second portion of the article has a second value of the mechanical property, and the first value is different from the second value.

FIG. 1A is a cross-sectional diagram of a hose 100 according to one embodiment. The hose 100 has a wall 102 with an outer radius 104 and an inner radius 106. The wall 102 defines a fluid passage 108. The hose 100 allows fluid to flow through the fluid passage 108.

The wall 102 includes a number of components. The first component is a continuous phase 110 made of a first material with a rigidity that has low variability. The rigidity of the first material does not vary strongly with temperature (i.e. exposure to mild amounts of thermal energy does not affect the rigidity or flexibility of the first material strongly) or with exposure to radiant energy. Standard polymeric materials used for hoses may be used for the first material.

The second component forms one or more inclusions 112 in the continuous phase 110. The inclusions 112 are made of, or include, a second material whose rigidity or flexibility is adjustable by exposure to thermal or radiant energy. The second material has rigidity or flexibility that varies much more strongly with temperature (i.e. thermal energy) and/or exposure to radiant energy than the first material. If the rigidity of a material is expressed as a function of some energy exposure R(E) where the energy exposure E may be a vector quantity if multiple discrete energy sources are used, the derivative D=δR/δE expresses how the rigidity of the material varies with exposure to one or more energy sources. If the derivative of the first material is D₁ and the derivative of the second material is D₂, a ratio X(E)=D₂/D₁ may be defined. The ratio X has a value between about 2 and 100, for example between about 3 and 10. In other words, dependence of rigidity of the second material on exposure to an energy, for example thermal and/or radiant energy, is between about 2 and 100 times the dependence of rigidity of the first material on exposure to the energy, for example between about 3 and 10 times.

The second material may be contained in an envelope 114 that allows easy manufacturing of the hose 100. The envelope 114 may be a plastic film, for example a polyethylene film that is strong and flexible enough to hold the second material without rupture during processing. The second material changes molecular composition upon exposure to particular energies, resulting in changed mechanical properties. The changed mechanical properties result in a change in rigidity of the wall 102. The second material may change from a liquid to a gel when exposed to a first energy, and from a gel to a liquid when exposed to a second energy different from the first energy. For example, the second material may include one or more monomers that polymerize when exposed to thermal energy or UV radiation. The monomers may be dispersed in a solvent to control the change in mechanical properties as the liquid becomes a gel. The resulting polymer may then decompose back to the constituent monomers upon exposure to a different thermal energy or UV radiation. Alternately, the second material may include one or more components that collectively change from a liquid to a gel when exposed to a first thermal energy or UV radiation, and back to a liquid when exposed to a second thermal energy or UV radiation.

Rigidity, and the change in rigidity, of the hose depends on the properties of the second material as liquid and gel, on the properties of the envelope 114, and the properties of the continuous phase 110. The rigidity also depends on the proportions of the various materials in the hose. Rigidity may be expressed as a modulus of elasticity, defined as stress applied to the material divided by strain, elongation or deformation, resulting from the stress. High modulus of elasticity, also called “modulus,” indicates a rigid material, while low modulus indicates a flexible material. Using the methods described herein, a hose can be made that has an overall bulk modulus (modulus of elasticity of all the combined components in the article) that varies by two orders of magnitude in some cases. For example, in one case, at its most rigid, the hose may have a bulk modulus of 10⁹ N/m², and at its most flexible, the hose may have a bulk modulus less than 10⁹ N/m², for example 5×10⁸ N/m². The wall 102 may have nominal thickness of 4.57 mm for a hose of diameter 25.40 mm. As a fraction of the hose outer diameter, the wall 102 may have nominal thickness of 0.1 to 0.4, for example 0.2.

The inclusions 112 have a diameter that may be up to 80% of the thickness of the wall 102. The inclusions may be distributed uniformly around the circumference of the wall 102, or may have any desired non-uniform distribution. For example, the inclusions may be grouped or clustered in a plurality of groups, and the groups may be uniformly distributed in the wall 102, resulting in a non-uniform distribution of the inclusions. The inclusions, or groups of inclusions, may be located at regular angular displacements around the circumference of the hose, in other words every n degrees of angular displacement, for example every 10 degrees or every 30 degrees. The inclusions may be located along a single circular arc within the hose wall 102, or along multiple circular arcs. For example, the hose wall 102 may have two or more “rows” of inclusions, and the inclusions may be arranged along radii of the hose, or may be staggered.

The inclusions may all have the same diameter. Alternately, a first plurality of inclusions may have a first diameter, while a second plurality of inclusions has a second diameter different from the first diameter. In one embodiment, inclusions of the first diameter are interspersed among inclusions of the second diameter, for example by alternating an inclusion of the first diameter with an inclusion of the second diameter along a circular arc of the hose. In another embodiment, a first plurality of inclusions of the first diameter are disposed along a first circular arc and a second plurality of inclusions of the second diameter are disposed along a second circular arc. It may be advantageous, in some cases, to position larger inclusions closer to the outer radius of the wall and smaller inclusions closer to the inner radius of the wall. As noted above, the number of inclusions 112 in the hose wall 102, and the size of the inclusions, affects the adjustability of the hose rigidity.

The inclusions 112 extend along a length of the hose 100. The inclusions may be continuous along the length of the hose 100, or the inclusions may be discontinuous with discrete lengths within the hose wall 102, or the inclusions may be mixed continuous and discontinuous inclusions. The inclusions may be substantially parallel to each other, or may be non-parallel in a random or patterned fashion. The inclusions may be parallel to a central axis of the hose, or the inclusions may wrap around the hose in either direction. A mixture of inclusions parallel to the central axis and wrapped inclusions may be used. For example, a first plurality of inclusions may be located at a first radius of the hose, and may be parallel to the central axis, while a second plurality of inclusions may be located at a second radius of the hose, and may be wrapped around the hose.

The hose 100 also includes one or more energy conduits 116 disposed through the continuous phase 110 of the wall 102. The energy conduits 116 are positioned to provide energy to the inclusions 112 to drive changing the modulus of second material, for example by changing the second material from liquid to gel and vice-versa. The energy conduits may be optical fibers in some cases, or resistive heating elements (or other thermal energy elements such as thermal fluid conduits) in other cases. Combinations of types of energy conduits may also be used. The energy conduits 116 carry thermal and/or radiant energy through the wall 102 of the hose to expose the inclusions 112, and the second material therein, to energy that causes polymerization or depolymerization, gelation or degelation, or other modulus change of the second material, or potions thereof. The energy conduits 116 are externally accessible as a terminus of the hose 100, as described further below, to couple the energy conduits to one or more energy sources. The energy conduits 116 may be wires, which may be jacketed or insulated, optical fibers, or fluid conduits to carrying heated fluid, if heat energy is desired for adjusting properties of the second material.

The second material in the inclusions includes a material that increases in molecular weight or viscosity upon exposure to a first energy and reverses such change upon exposure to a second energy different from the first energy. Such materials include ionic liquids, hydrogen bonding systems, metal chelating systems, isomerizing molecules, and reversible polymers. The materials may be energized to change state by photonic energy, thermal energy, and/or electric energy.

In some cases the second material is a self-assembled gel, such as a chemical gel, an organogel, or a hydrogel, that gels on exposure to the first energy and liquefies on exposure to the second energy. Such gels may be based on covalent chemistry, hydrogen bonding, halogen bonding, Van der Waals forces, electrostatic forces, charge transfer, donor-acceptor interactions, π-π stacking, metal coordination interactions, and combinations thereof. Gelators that may be used include bis(1,2-laurylamido)cyclohexane, bis(1,2-laurylcarbamido)cyclohexane, 2-stearoylglutamic acid, a hydroxynonadecanoic acid (for example 13-hydroxynonadecanoic acid), bis(2,4-isohexylcarbamido)toluene, N,N′-dibenzoyl-L-cystine, and divalyl oxalamide. In addition, a copper acetate/oxalic acid solution in water, and a diaminocyclohexane L-tartrate solution in aqueous HCl/methanol are also gelators. The (methylated) tetrapeptide Tyr—Tyr—Gly*—Tyr(Me), where the glycine unit is functionalized with an azobenzene unit, is known to gel by thermal, ultrasound, or light stimuli. In particular, the tetrapeptide is known to undergo a conformation-driven change from liquid to gel when irradiated with 366 nm radiation, and subsequently from gel to liquid when exposed to broad-spectrum visible light (e.g. room light or terrestrial sunlight). It is also known that the oxalic acid system and the diaminocyclohexane system can undergo thermally triggered gel transitions at or near room-temperature.

Any material that undergoes a reversible transition in modulus when exposed to an energy stimulus can be used for the second material provided the energy conduits 116 are configured to provide the energy stimulus that triggers the transition in the material. Many polymers can undergo such transitions under favorable circumstances. Examples include polyisocyanates such as poly(n-hexyl-co-S-2,2-dimethyl-1,3-dioxolane-4-methylene-isocyanate) in hexane solvent, poly(n-butyl-isocyanate) in benzene or toluene, poly(n-hexyl-isocyanate), and copolymers thereof with branched poly(alkylisocyanates), in hydrocarbon solvents, poly(n-nonyl-isocyanate) in kerosene; and polypeptides such as alkyl-substituted poly(glutamic acids) and esters thereof, for example octadecyl esters of poly(glutamic acids) and poly(benzylglutamic acid) in solvents such as dimethylformamide (DMF), hexane, and octane.

The second material may include an active material that reversibly polymerizes when exposed to UV radiation. Photo-reversible cross-linking polymer systems can be made to form reversible gels that respond to photochromic stimulus. Hydrophilic polymers such as polyethers, polyoxalates, polycarbonates, polyalcohols, polyurethanes, and polyacrylates—for example poly(ethylene glycol), poly(vinyl alcohol), or poly(propylene glycol), and copolymers and multi-polymers thereof—can be combined with, or functionalized to include, photoresponsive cross-linking agents or groups to form reversible hydrogels in water or aqueous solution. For example, an aqueous solution of cinnamylidene acetate terminated polyalkylene oxide will form a gel by cross-linking in the unsaturated alkyl chain of the cinnamylidene moiety when exposed to light having wavelength of 300-400 nm, and will revert to liquid when exposed to light having wavelength less than 300 nm, for example around 250 nm.

Various polymer systems used for 3D printing can form photo-reversible chemical gels or hydrogels. Polymers such as polylactic acid, poly(acrylonitrile butadiene styrene), polystyrene, nylon, high density polyethylene, polycarbonate, polyvinyl alcohol, and polyethylene terephthalate, styrenic block copolymers (TPE-s), thermoplastic olefins (TPE-o), elastomeric alloys (TPE-v or TPV), thermoplastic polyurethanes (TPU), thermoplastic copolyesters, and thermoplastic polyamides can be functionalized with cross-linkable moieties such as dimers or co-dimers of cinnamic acid, coumarin, thymine, and stilbene. Such polymers may be dissolved in appropriate solvents at concentrations near a thickening point of the solutions to provide a liquid mixture that will increase in viscosity when exposed to radiation at wavelengths between 300 nm and 350 nm, and will return to the liquid state when exposed to radiation at wavelengths less than 300 nm, such as 250 nm to 300 nm, for example about 260 nm.

FIG. 1B is a cross-sectional view of a hose 170 according to another embodiment. The hose 170 has a wall 102 with a plurality of adjustable rigidity members 172 disposed in the wall 102. Each of the adjustable rigidity members 172 includes one of the inclusions 112 and one or more of the energy conduits 116 grouped together in proximity. The adjustable rigidity members 172 are disposed in the wall 102 along two concentric radii of the hose 170, with a first plurality of adjustable rigidity members 172 disposed at a first radius of the hose 170 and a second plurality of adjustable rigidity members 172 disposed at a second radius of the hose 170 different from the first radius. Within each adjustable rigidity member 172, the energy conduits 116 may be parallel to the inclusions 112 or may be wrapped around the inclusions 112 in a spiral or helical fashion. As noted above, some or all of the adjustable rigidity members 172 may also spiral around the circumference of the hose 170 in the wall 102 thereof.

FIG. 1C is a cross-sectional view of a hose 180 according to another embodiment. The hose 180 has a wall 102 with a plurality of adjustable rigidity members 182 disposed therein. Each of the adjustable rigidity members 182 has an inclusion 112 with an energy conduit 116 disposed inside the inclusion 112. The adjustable rigidity members 182 of FIG. 1C are shown disposed at a constant radius of the hose 180, but in alternate embodiments, radial position of the adjustable rigidity members 182 may vary. For example, a first plurality of adjustable rigidity members 182 may be disposed at a first radius of the hose 180, while a second plurality of adjustable rigidity members 182 are disposed at a second radius of the hose 180, all within the wall 102.

The hoses of FIGS. 1A-1C can be made by extruding the first material through a die that has holes for co-feeding the inclusions and the energy conduits. FIG. 2 is a schematic cross-sectional view of an extrusion apparatus 200 for making the hose 100 of FIG. 1. The apparatus 200 includes an extruder 202 with a barrel 204 through which the first material is extruded, and a die 206 for forming the first material into the hose 100. The die 206 has, for example, a melt chamber 208 for flowing the first material in a molten state and an annular exit 210 for releasing the first material to solidify in an annular shape. A conical diverter 212 may be attached to the body of the die 206 at a location in the melt chamber 208 to form the first material into the annular shape of the hose 100. One or more openings 214 may be provided in the die 206 to allow the inclusions 112 and/or the energy conduits 116 to be fed through the die and into the melt chamber 208 for incorporation into the hose 100. Although only one or two openings are shown in the cross-sectional view of FIG. 2, the die may include multiple such openings for feeding a plurality of the inclusions 112 and the energy conduits 116.

The die 206 may additionally include a cowl 216 for positioning the inclusions 112 and energy conduits 116 for feeding through the openings 214. The cowl 216 may have passages that align with the openings 214, or the cowl 216 may be a continuous or semi-continuous annular opening that extends along an end portion 218 of the extruder 202. The cowl 216 may include feeding aids that, for example, prevent slippage of the inclusions 212 or the energy conduits 214 in the die 206. The cowl 216 may also include sealing members to prevent leakage of the polymer material flowing through die 206 into the cowl 216.

As noted above, the inclusions 112 and energy conduits 114 may be arranged substantially parallel to the axis of the hose 100 such that the inclusions 112 and energy conduits 114 extend substantially straight down the length of the hose 100. In alternate embodiments, the inclusions 112 and energy conduits 114 may be arranged with some azimuthal distribution along the circumference of the hose 100. For example, the inclusions 112 and energy conduits 114 may wrap around the hose 100 in a helical fashion. Referring to FIG. 2, an actuator 220 (shown in phantom as an optional element) may be coupled to the die 206 to rotate the die 206 such that the inclusions 212 and energy conduits 214 may be arranged helically within the hose 100.

The inclusions 112 may be fed in a state wherein the second material is a low-viscosity fluid contained in the envelope such that the inclusion 112 can be fed through the die 206 easily. In some embodiments, the inclusions 112 include an inert fluid when fed through the die 206, instead of a gel-transition fluid, since the melt chamber 208 may be maintained at an elevated temperature that may cause gel transition in some materials. In such embodiments, the inert fluid is typically replaced, after the hose is formed, using access ports that may be provided in the hose 100.

FIG. 3 is a cross-sectional view of a connector 300 that may be applied to the hose 100 after extrusion from the apparatus 200. The connector 300 comprises a first portion 302 that mates with a second portion 304. The first portion 302 has a first passage 306 and a plurality of second passages 308. The second portion 304 has a third passage 310. The first passage 306 is formed through a protrusion 312 of the first portion 302. The protrusion 312 extends along an axis 325 of the connector 300 and mates with a recess 314 of the second portion 304. When the first and second portions 302 and 304 are mated, with the protrusion 312 mated with the recess 314, the first and third passages 306 and 310 align to form a single passage for fluid flow.

The connector 300 is suited for connecting two lengths of hose like the hose 100 in a hose assembly 399. A first length 150 of the hose assembly 399 and a second length 160 of the hose assembly 399 can be connected quickly by mating the first portion 302 and the second portion 304 of the connector 300. The passage formed by the first and third passage 306 and 310 provides fluid communication from an interior of the first length 150 to an interior of the second length 160 such that fluid can flow from the first length 150 through the passage, through the connector 300, to the second length 160, and vice versa. A seal may be formed between the first portion 302 and the second portion 304 by providing sealing members at any convenient interface surface between the first portion 302 and the second portion 304. In the embodiment of FIG. 3, a sealing member 316 is located on an outer surface 318 of the protrusion 312. Multiple sealing members 316 may be used, if desired, and may be located along one or more additional interface surfaces between the first portion 302 and the second portion 304. The sealing members 316 are typically made of a compliant material to support insertion of the protrusion 312 of the first portion 302 into the recess 314 of the second portion 304.

Alternately, the first portion 302 can be sealed to the second portion 304 using an adhesive or sealant material applied to the interface between the first portion 302 and the second portion 304. The adhesive or sealant can be applied to one or more surfaces of the first portion 302 that will interface with surfaces of the second portion 304, for example the outer surface 318 of the protrusion 312, before insertion of the first portion 302 into the second portion 304. Upon insertion, the adhesive or sealant material contacts surfaces of the second portion 304 and forms a seal between the surfaces of the first portion 302 and the second portion 304.

An extension 322 of the first portion 302 extends from an edge 323 of the first portion along the axis 325 of the connector 300 and fits around a first end 152 of the first length 150. The second portion 304 fits within a second end 162 of the second length 160. A restraint 324 may be provided along the outer surface 104 of the second end 162. The restraint 324 may include an inner ridge 326 for engaging with a circumferential groove 328 formed in the extension 322 of the first portion 302. Engaging the inner ridge 326 with the groove 328 provides additional connection security between the first portion 302 and the second portion 304, and may provide an axial force urging the first portion 302 against the second portion 304 so that the interface surfaces between the first portion 302 and the second portion 304 experience a sealing force. The restraint 324 may be flexible to facilitate engagement of the inner ridge 326 with the groove 328. Gaps 335 may be provided in the restraint 324 to allow the restraint 324 to flex as the inner ridge 326 is engaged with the groove 328. The restraint 224 may be adhered to the outer surface 104 using an adhesive, or may be physically fastened to the hose along the outer surface 104, for example using rivets, barbs, or one or more clamps.

Each of the passages 308 of the first portion 302 is disposed in a peripheral area 336 of the first portion 302 radially inward of the extension 322. Each of the passages 308 extends in a direction parallel to the axis 325 and aligns with an inclusion 112 or an energy conduit 114 of the first length 150 of the hose assembly 399. The passages 308 provide access for inclusions 112 and energy conduits 114 of the second length 160 to penetrate the first length 150 and engage with the inclusions 112 and energy conduits 114 of the first length 150. The passages 308 may have electrically conductive walls to promote an electrical connection between the energy conduits 114 of the two lengths 150 and 160, if desired. The passage 308 may have reflective walls to promote transmission of radiation between the energy conduits 114 of the two lengths 150 and 160, if desired. The passages 308 may have thermal insulation to promote transmission of thermal energy between the energy conduits 114 of the two lengths 150 and 160, if desired. Each passage 308 may have a flared opening (the flaring is not visible in FIG. 3) to promote easy alignment of the inclusions 112 and energy conduits of the second length 150 with the passages 308. When the first and second portions 302 and 304 are fully engaged, the extension 322 of the first portion forms an interface with the restraint 324 that may provide a light barrier to prevent loss of radiation from the energy conduits 114, if desired. The restraint 324 may be provided with reflective interior surfaces, if desired, to further promote retention of radiation from the energy conduits 114.

Using the connector 300, lengths of the hose assembly 399 may be fitted together such that the inclusions 112 and energy conduits 114 may continue along successive lengths of the hose assembly 399. One or more portals 330 may be provided, if desired, aligned through the restraint 324 and the first portion 302, penetrating through the first portion 302 in a radial direction thereof from the edge 323 to one or more of the passages 308 to provide access to the inclusions 112 and/or the energy conduits 114 when the first portion 302 is engaged with the second portion 304. A first portal 330A is provided through the restraint 324, and a second portal 330B is provided through the first portion 302. The first portal 330A aligns with the second portal 330B when the first portion 302 is engaged with the second portion 304 to form a portal 330 extending radially from an outer surface 331 of the restraint 324 to one of the passages 308.

The portals 330 may be energy input ports used to couple energy to the energy conduits 114, for example by connecting a source of electricity, light, or thermal energy such as a hot fluid, to the energy conduits 114. The portals 330 may include threading, if desired, to facilitate connecting the source of energy to the connector 300. The portals 330 may also include flared openings, if desired, to facilitate alignment of connection members into the connector 300. In the event different types of energy conduits 114 are disposed in the same hose, for example optical fibers and resistive heat wires, the portals 330 may be shaped, differentially threaded, or otherwise formed differently for electrical connections and optical connections to prevent connecting an electrical source to an optical portal and vice versa.

It should be noted that in some embodiments, the energy conduits 116 may be merely tubes for flowing an energy medium, usually a thermal fluid, through the walls of the hose assembly 399. In such cases, no fiber or wire is used as an energy conduit 116, and the energy conduit 116 is merely an open space in the wall of the hose. A portal 330 may connect to such an energy conduit 116 to provide connection to a thermal fluid source to flow the thermal fluid through the wall 104 of the hose 100 by operation of the energy conduit 116.

In other embodiments, multiple chemical systems may be used for the inclusions 112. The different chemical systems may change mechanical properties under different stimuli, for example different wavelengths of light, different temperatures, or combinations of wavelengths of light and temperatures, to provide different flexing characteristics for the hose under different conditions. Such a hose can be set to different stiffnesses at different times by energizing the different chemical systems at different times. One length of the hose may be equipped with different energy sources coupled to different energy ports so that the energies can be turned on and off at will. The different lengths of the hose may be differently energized to provide a hose assembly with a first length that has a first stiffness and a second length that has a second stiffness different from the first stiffness. The stiffness of each length can be varied independently by varying the energy input to each length.

The configurable hose 100 described above, and the hose assembly 399 featuring lengths of the hose 100, provides selectable flexural characteristics that can change the shear and torsion stiffness of the hose in virtually any desired way. The hose may be operated to have a first stiffness in a first direction different from a second stiffness in a second direction. A ratio of the first stiffness to the second stiffness may be changed by operation of the energy conduits to change the state of selected inclusions. By shaping the inclusions and energy conduits in the walls of the hose, selective control of torsional and bending stiffness may be provided. For example, by providing a first plurality of inclusions and energy conduits operating on a first energy pattern in a helical pattern and a second plurality of inclusions and energy conduits operating on a second energy pattern in an axial pattern (parallel to the axis of the hose), the first energy pattern can be used with the first energy conduits to adjust torsional stiffness of the hose while minimizing effect on bending stiffness and the second energy pattern can be used with the second energy conduits to adjust bending stiffness while minimizing effects on torsional stiffness.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. When a range is used to express a possible value using two numerical limits X and Y (e.g., a concentration of X ppm to Y ppm), unless otherwise stated the value can be X, Y, or any number between X and Y.

The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and their practical application, and to enable others of ordinary skill in the art to understand the invention.

What is claimed is:

1. A hose, comprising:
a wall with a first material, a second material, and one or more energy conduits, wherein the first material has a first rigidity with a first variability, and the second material has a second rigidity with a second variability, the first variability depends on energy emitted from the one or more energy conduits, and the second variability is substantially independent of energy emitted from the one or more energy conduits.

2. The hose of claim 1, wherein the second material is contained within a tube disposed in the wall.

3. The hose of claim 2, wherein the one or more energy conduits comprises at least one optical fiber.

4. The hose of claim 3, further comprising a connector disposed at an end of the hose, the connector including a seal member and a passage through which at least one of the energy conduits is disposed.

5. The hose of claim 4, wherein the second material includes an active material that reversibly polymerizes in the presence of UV radiation.

6. The hose of claim 5, wherein the second material changes from liquid to gel when exposed to radiation at a first wavelength and from gel to liquid when exposed to radiation at a second wavelength.

7. The hose of claim 6, wherein the second material also includes a diluent.

8. A connector for a hose assembly, the connector comprising:
a first portion having a protrusion with a first axial passage; and
a second portion having a recess that mates to the protrusion, the recess having a second axial passage that aligns with the first axial passage when the recess is mated to the protrusion, wherein the first portion has a plurality of peripheral passages formed through a peripheral region of the first portion radially inward of an edge of the first portion and extending along an axial direction of the connector.

9. The connector of claim 8, wherein the first portion includes a plurality of portals, each portal extending radially from the edge of the first portion to one of the peripheral passages.

10. The connector of claim 9, further comprising a sealing member disposed along an outer surface of the protrusion.

11. The connector of claim 10, wherein the first portion has an axial extension with a circumferential groove.

12. The connector of claim 11, further comprising a restraint with an inner ridge that engages with the circumferential groove.

13. A hose assembly, comprising:
a first hose length comprising a first wall with a continuous phase made of a first material, a first plurality of inclusions made of a second material, and one or more first energy conduits, wherein the first material has a first rigidity with a first variability, and the second material has a second rigidity with a second variability, the first variability depends on energy emitted from the one or more first energy conduits, and the second variability is substantially independent of energy emitted from the one or more first energy conduits;
a second hose length comprising a second wall with a continuous phase made of the first material, a second plurality of inclusions made of the second material, and one or more second energy conduits; and
a connector for joining the first hose length to the second hose length, the connector comprising a first portion coupled to the first hose length and a second portion coupled to the second hose length, the first portion having a plurality of peripheral passages parallel to an axis of the connector and aligned with the first plurality of inclusions and the one or more first energy conduits to receive the second plurality of inclusions and the one or more second energy conduits.

14. The hose assembly of claim 13, wherein the first portion of the connector has a protrusion, the second portion of the connector has a recess, and the protrusion mates with the recess.

15. The hose assembly of claim 13, wherein the one or more first energy conduits and the one or more second energy conduits are optical fibers.

16. The hose assembly of claim 13, wherein the first portion of the connector includes a port extending radially through the first portion from an external surface of the first portion to one of the peripheral passages.

17. The hose assembly of claim 13, wherein the second material includes one or more compounds that reversibly polymerizes when exposed to UV radiation.

18. The hose assembly of claim 17, wherein the second material changes from liquid to gel when exposed to radiation at a first wavelength and from gel to liquid when exposed to radiation at a second wavelength.
